(19) United States
(12) Patent Application Publication
(10) Pub. No.: US 2009/0256872 A1
(43) Pub. Date: Oct. 15, 2009

(54) Print Head and Printer Equipped Therewith

(75) Inventors: Yuichi Yamakawa, Chiba (JP); Naonobu Sawada, Chiba (JP)

Correspondence Address: CROWELL & MORING LLP;INTELLECTUAL PROPERTY GROUP, P.O. BOX 14300, WASHINGTON, DC, 20044-4300, US

(73) Assignee: Seiko Precision Inc., Narashino-shi (JP)

(21) Appl. No.: 12/296,914

(22) PCT Filed: Feb. 20, 2007
(86) PCT No.: PCT/JP2007/053047

§ 371 Date: May 19, 2009

(30) Foreign Application Priority Data
Apr. 10, 2006 (JP) 2006-107274

(51) Int. Cl. B41J 25/308

(52) U.S. Cl. 347/8

(57) ABSTRACT

A print head which prevents printing force from being reduced by making the distance between the tip of a printing wire and a printing medium adjustable, and a printer equipped therewith are provided. When the tip of a wire (11) abrades through use of a print head (1) and printing force is reduced due to an increase in a distance between the printing surface of a print sheet (20) and the tip of the wire (11), a pull-out spacer (14) is pulled out. As the pull-out spacer (14) is pulled out, a distance L2 between the tip of a trace roller (12) and a reference surface (16a) of a frame is shortened to L1−2t, and a distance between the printing surface of the print sheet (20) and the reference surface (16a) of the frame, which is equal to a distance L2, is also shortened. A distance between the tip of the projecting wire (11) and the printing surface of the print sheet (20) is shortened to d1−2t, and the tip of the wire (11) approaches the printing surface of the print sheet (20) so that the distance becomes the distance before the wire (11) is abraded away.

### TECHNICAL FIELD

The present invention relates to a print head which strikes the tips of wires to print on a printing medium, and a printer equipped therewith.

### BACKGROUND ART

A dot-impact print head is used for a printer, a recorder and the like. As such a print head, as disclosed in Patent Literature 1, there is one having a plurality of printing levers which swings by being attracted by magnetic force generated at a magnetic core part with power supplied to an exiting coil and urged to a standby position by a return spring, and a plurality of printing wires which are respectively fixed to one ends of the printing levers and are urged by the printing levers to strike the printing surface of a print sheet via an ink ribbon to print thereon.

As described in Patent Literature 2, there is another one provided with a roller for securing a distance between the tip portions of printing wires, and the printing surface of a print sheet.
Patent Literature 1: Unexamined Japanese Patent Application KOKAI Publication No. H11-334115
Patent Literature 2: Unexamined Japanese Patent Application KOKAI Publication No. H11-179997

### DISCLOSURE OF THE INVENTION

### Problems to be Solved by the Invention

While the print head disclosed in the Patent Literature 1 and Patent Literature 2 mentioned above is being used for a long time, the tips of the printing wires wear out (are abraded away) as the tips are hit against the printing surfaces of print sheets repeatedly.

When the tips of the printing wires wear out this way, there arises a problem that the tips of the printing wires do not reach the printing surface of a print sheet so that the printing force (impact force) to a print sheet becomes lower, causing blurring of printing.

According to print head of Patent Literature 2, an opening for fastening the support for the roller to a career, which carries the print head, extends in the adjustment direction, so that the distance between the tips of a printing wires and a printing surface can be adjusted by adjusting the position of the roller to the printing surface by loosening a screw.

However, the print head does not have a structure to control (or define) the amount of adjustment, making the adjusting work troublesome.

The present invention has been made in view of the above-mentioned situation, and it is an object of the invention to provide a print head which can easily adjust the distance between the tips of printing wires and a printing medium for preventing reduction in printing force, and a printer having the printer head.

### Means for Solving the Problems

To achieve the object a print head according to the present invention including: a plurality of wires having tip portions to be struck against a printing surface of a printing medium; a rotatable roller which slides on the printing medium to secure distances between the printing medium and the tip portions of the wires; a support for the roller; and a frame to which the support for the roller is attached, comprising: a spacer between the support for the roller and the frame for adjusting the distances between the printing medium and the tip portions of the wires; and the spacer being held between the support for the roller and the frame in a pull-outable manner.

There may be a plurality of spacers.

The spacer may have a knob formed disproportionately at either right side or left side.

The spacers may be arranged one on another with a top of one facing a bottom of another alternately.

The knob may be structured to have a hole formed therein.

The support for the roller may be fastened to the frame by a screw, and the spacer may be structured to have a groove which has one end open at a periphery of the spacer and through which the screw penetrates.

The print head may be structured to further have a fixed spacer between the support for the roller and the frame, the fixed spacer being fixed therebetween together with the spacers.

To achieve the object, a printer according to the invention is equipped with the above-described print head.

### Effect of the Invention

The present invention can provide a print head which can adjust the distance between the tips of printing wires and a printing medium to prevent reduction in printing force, and a printer provided therewith.

### BRIEF DESCRIPTION OF THE DRAWINGS

FIG. 1 An exploded perspective view showing the configuration of a print head according to an embodiment of the invention.

FIG. 2 A side view of the print head shown in FIG. 1.

FIG. 3 A front view of the print head shown in FIG. 1.

FIG. 4 A plan view of the print head shown in FIG. 1.

FIG. 5 (a) is top view of a printer provided with the print head shown in FIG. 1, and (b) is a cross-sectional view of the printer shown in (a) as viewed from A-A.

FIG. 6 (a) is an explanatory view showing a state before removing a removal spacer of the print head shown in FIG. 1, and (b) is an explanatory view showing a state after removing the removal spacer of the print head shown in FIG. 1.

### DESCRIPTION OF REFERENCE NUMERALS

1 Print head
11 Wire
12 Tracing roller
13 Roller support
14 Pull-out spacer
14a Knob
16 Frame
16a Reference surface (bottom)
17 Lock screw
18 Height adjusting spacer
20 Print sheet
30 Printer
32 Ink ribbon
36 Platen

### BEST MODE OF CARRYING OUT THE INVENTION

A print head according to an embodiment of the present invention will be described below with reference to the accompanying drawings. The print head 1 is used for a dot-impact printer, and performs printing as the tips of wires 11 are struck against the printing surface of a printing medium such as a print sheet 20 via an ink ribbon 32.

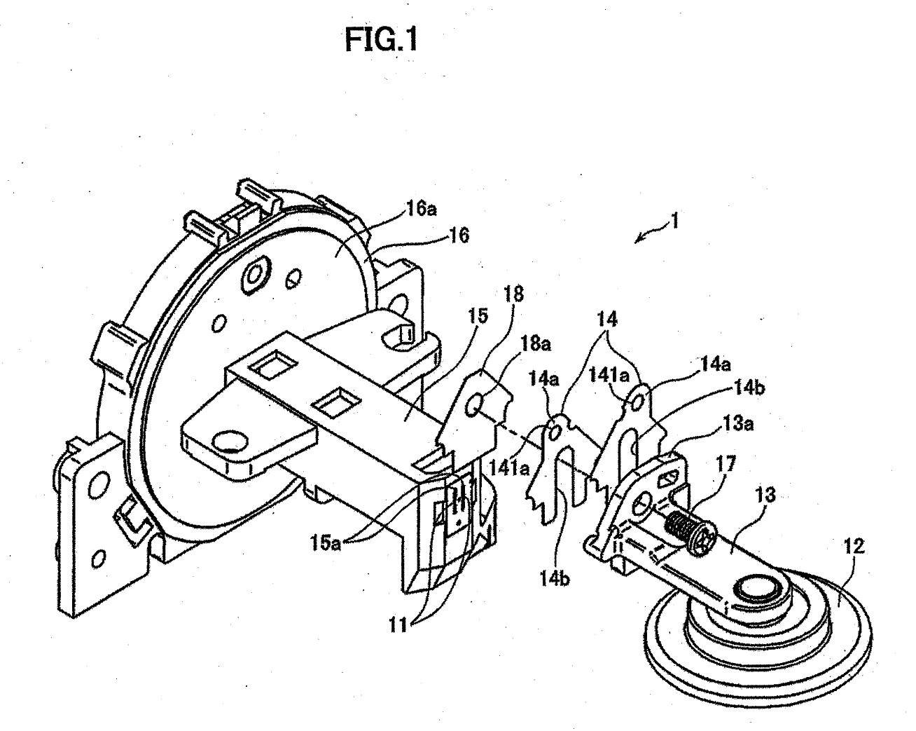

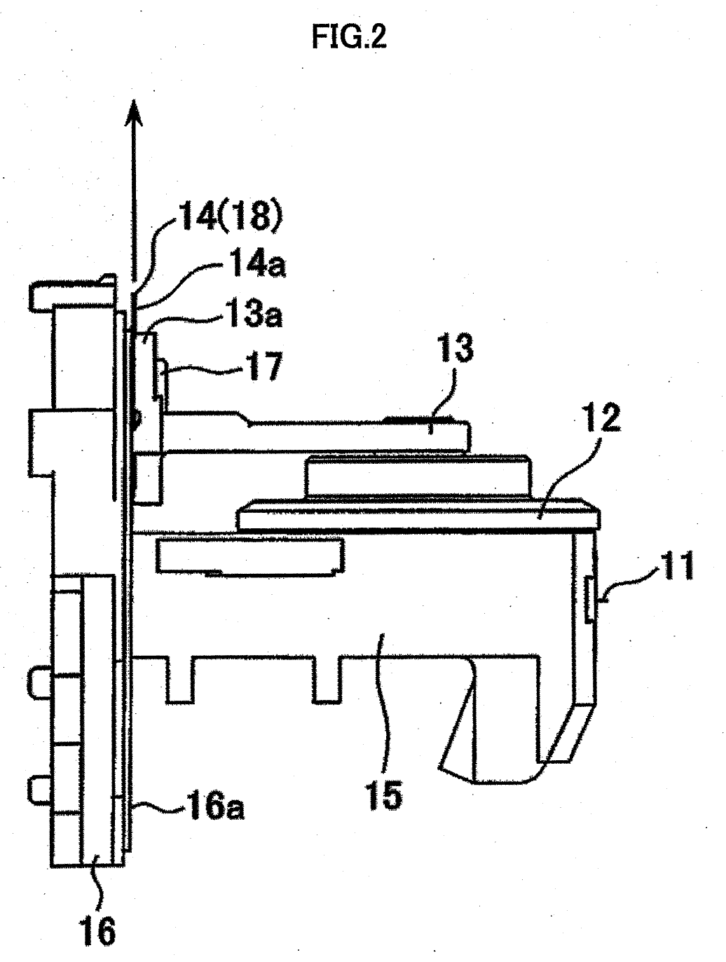

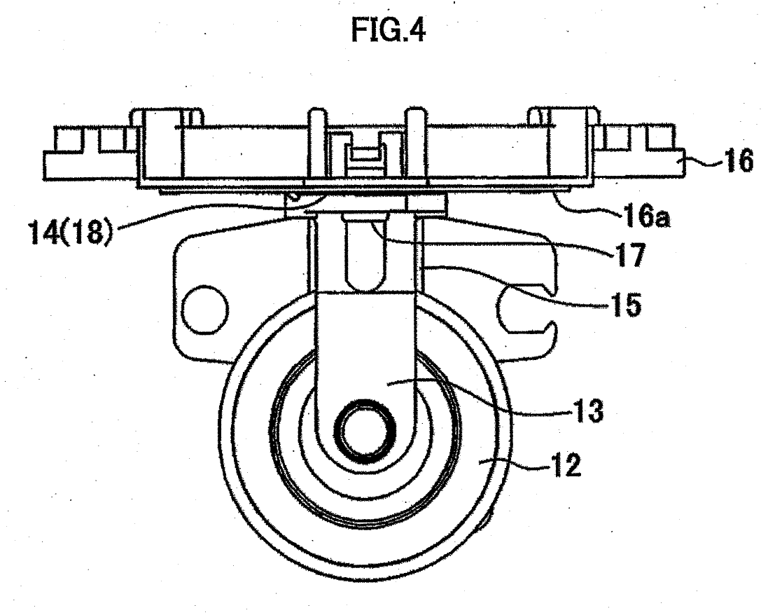

As shown in FIGS. 1 to 4, the print head 1 has wires 11, a trace roller 12, a roller support 13 which supports the trace roller 12, pull-out spacers 14, a wire frame 15, a frame 16, and a height adjusting spacer 18. In the frame 16, a plurality of levers (not shown) having one ends respectively fixed to the rear end portions of the plurality of wires 11 are arranged radially, and coils, a yoke, etc. which generate the magnetism to rock (swing) a plurality of levers are also arranged.

As each of the levers is rocked by magnetism-originated adsorption, the tip of the wire 11 projects through an opening 15a of the wire frame 15 to be struck on a printing surface.

A plurality of wires 11 are disposed in the wire frame 15. The wires 11 are disposed in the wire frame 15 in such a way that the tips of the wires 11 can project from two openings 15a formed at the distal end of the wire frame 15. The wire frame 15 is attached so as to stand upright on a bottom 16a of the frame 16.

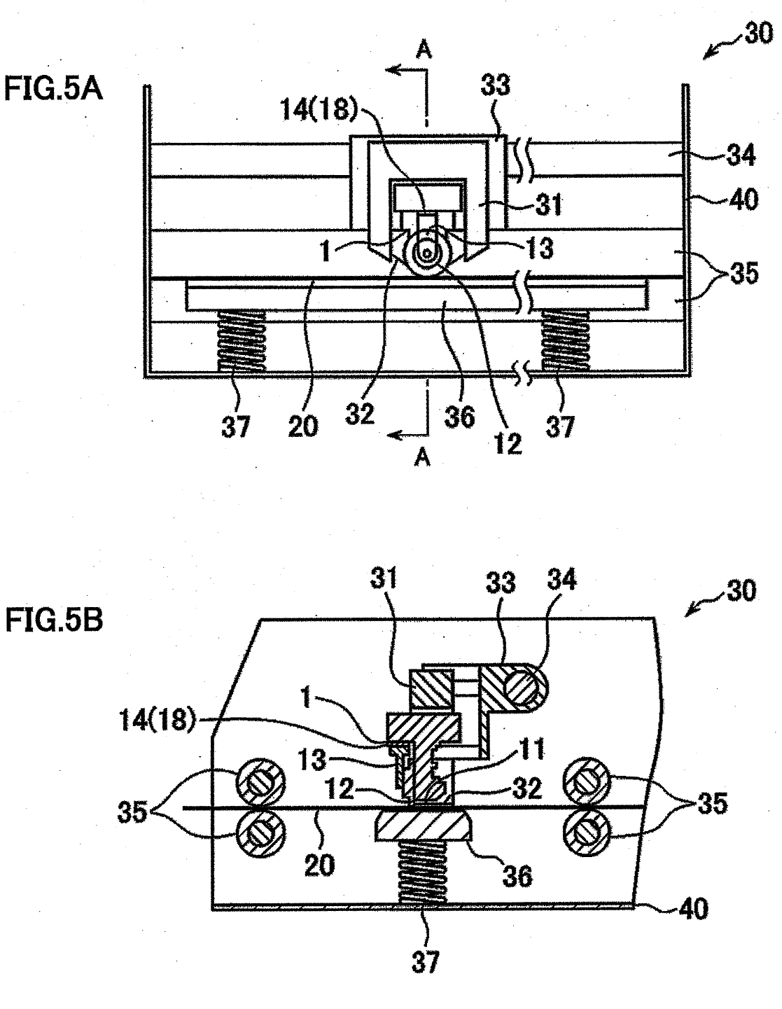

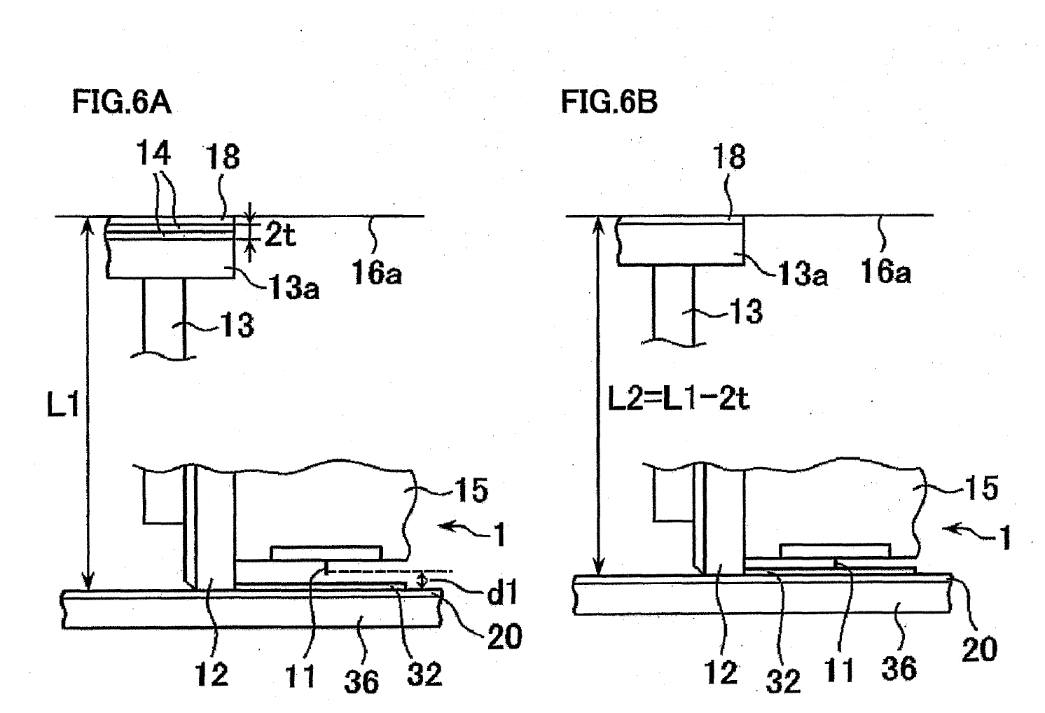

The trace roller 12 is for securing the distance between the print sheet 20 and the tips of the wires 11, as shown in FIGS. 5 and 6. As shown in FIG. 5, the trace roller 12 presses down the fed print sheet 20 on a platen 36 to stabilize the distance between the print sheet 20 and the tips of the wires 11. The trace roller 12 is freely rotatable and slides on the print sheet 20.

The trace roller 12 is supported by the roller support 13 in such a way as to be freely rotatable in the direction of movement of the print head 1. The roller support 13 is attached to stand upright on the bottom 16a of the frame 16. That is, the wire frame 15 having the wires 11 disposed therein and the roller support 13 are attached to the frame 16 so as to be in parallel.

The roller support 13 is fixed to the bottom 16a of the frame 16 by the lock screw 17 via the height adjusting spacer 18 and the pull-out spacer(s) 14. The trace roller 12 is arranged close to the upper part of the wire frame 15.

The height adjusting spacer 18 is a spacer for adjusting the height of the trace roller 12 from the reference (bottom) surface 16a of the frame 16. A fixation hole 18a for the lock screw 17 to fix the height adjusting spacer 18 between the roller support 13 and the reference surface 16a of the frame 16 is formed in the height adjusting spacer 18.

The pull-out spacer(s) 14 is a spacer which can be pulled out to adjust the height of the trace roller 12 from the reference surface 16a of the frame 16, as shown in FIG. 6. That is, the pull-out spacer(s) 14 is pulled out to adjust the height of the trace roller 12, shortening the distance between the print sheet 20 and the reference surface 16a of the frame 16, thus shortening the distance between the print sheet 20 and the tips of the wires 11.

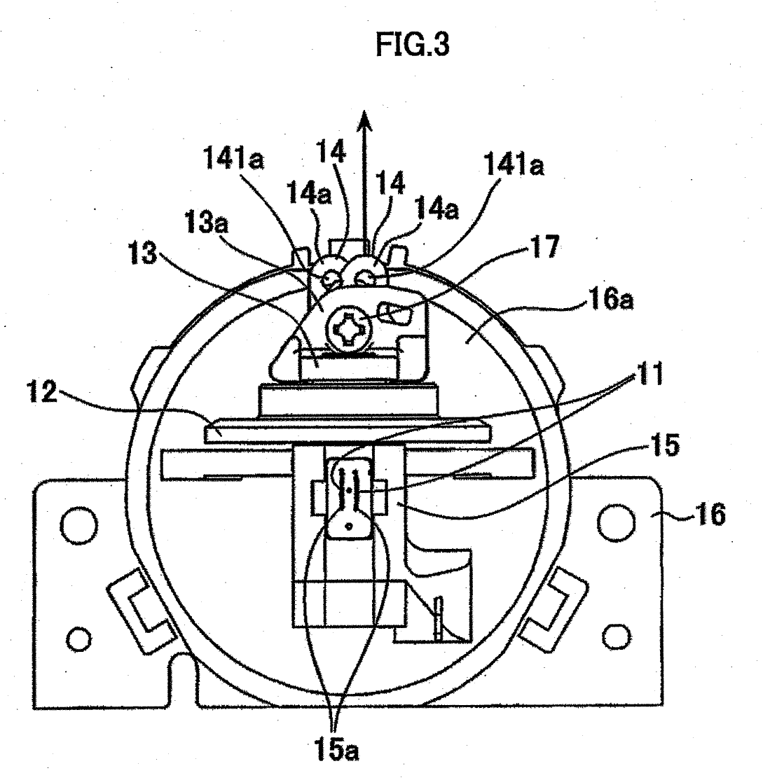

There are two pull-out spacers 14. A knob 14a having a round hole 141a formed therein and a groove 14b into which the lock screw 17 is to be fitted loosely are formed in each of the pull-out spacers 14. The knob 14a is formed disproportionately to either the right side or left side. Therefore, as shown in FIGS. 1 and 3, as two pull-out spacers 14 are arranged one on another alternately with one pull-out spacer 14 placed topside bottom on the other pull-out spacer 14, the knobs 14a of the two pull-out spacers 14 are positioned to the right and left, respectively. The round hole 141a makes the knob 14a easier to hold.

The two spacers 14 are fixed by the lock screw 17 between the height adjusting spacer 18 and a flange 13a of the bottom of the roller support 13. As shown in FIG. 3, the spacers 14 are arranged such that the knobs 14a are outside the periphery of the flange 13a so as not to overlap with and not be hid behind the flange 13a of the roller support 13.

Since the lock screw 17 is merely fitted loosely into the grooves 14b, the pull-out spacers 14 can be held easily and can be pulled out easily by loosening the lock screw 17. The thickness of the pull-out spacer 14 is about 0.05 min.

Next, a printer 30 equipped with this print head 1 will be described. As shown in FIG. 5, the printer 30 has the print head 1, a ribbon cassette 31 set to the print head 1, an ink ribbon 32 provided in the ribbon cassette 31, a carriage 33 for the print head 1, a carriage shaft 34 which supports the carriage 33 in such a way as to be movable in a longitudinal direction in FIG. 5 (a), feed rollers 35 for feeding the print sheet 20 in an arrowhead direction in FIG. 5 (b), a platen 36 which supports the print sheet 20, and an urging spring 37 which urges the platen 36 in the direction of the print head 1. The carriage shaft 34 and the feed rollers 35 are put across a casing 40 in parallel.

In the printer 30, while the print head 1 having the ribbon cassette 31 set therein is moved in the extension direction of the carriage shaft 34 via the carriage 33, the print sheet 20 is fed by the feed rollers 35 in a direction perpendicular to the extension direction of the feed rollers 35.

The tips of the wires 11 are selectively made to project from the openings 15a of the wire frame 15 of the print head 1 to cause the tips of the wires 11 to strike on the printing surface of the print sheet 20 supported on the platen 36 via the ink ribbon 32, thereby making printing.

A method of adjusting the distance between the print sheet 20 and the tips of the wires II by pulling out the pull-out spacer 14 will be described referring to FIG. 6. For easier understanding, a description will be given of an example where the two pull-out spacers 14 are pulled out together.

The state before pulling out the pull-out spacers 14 is shown in FIG. 6(a), and the state after pulling out the two pull-out spacers 14 is shown in FIG. 6(b). As shown in FIG. 6(a), given that the distance between the tip of the trace roller 12 and the reference surface 16a of the frame 16 before pulling out the pull-out spacers 14 is L1, the thickness of one pull-out spacer 14 is t, and the distance between the tips of the projecting wires 11 and the printing surface of the print sheet 20 before sampling (pulling out) the pull-out spacers 14 is d1.

In case where as the print head 1 is used, the tips of the wires 11 are worn out, increasing the distance between the printing surface of the print sheet 20 and the tips of the wires 11 and reducing the printing force, the two pull-out spacers 14 are pulled out from the print head 1 in the state shown in FIG. 6(a). When the two pull-out spacers 14 are pulled out from the print head 1, the distance L2 between the tip of the trace roller 12 and the reference surface 16a of the frame 16 is shortened to L1−2t. This shortened distance L2 is also the distance between the printing surface of the print sheet 20 and the reference surface of the frame 16.

As a result, the distance between the tips of the projecting wires 11 and the printing surface of the print sheet 20 is also shortened to d1−2t, the tips of the wires 11 come closer to the printing surface of the print sheet 20 to provide the distance before wear-out of the wire 11. This can provide good printing again.

Even when the tips of the wires 11 are worn out, by pulling out the pull-out spacers 14 in the print head according to the embodiment, the distance between the tips of the wires 11 and the printing surface of the print sheet 20 can be adjusted to be shorter, thus making it possible to prevent the printing force from being reduced.

Since the print head according to the embodiment has two pull-out spacers 14, the distance between the tips of the wires 11 and the printing surface of the print sheet 20 can be adjusted gradually.

In the print head according to the embodiment, as two pull-out spacers 14 are arranged one on another alternately with one pull-out spacer 14 placed topside bottom on the other pull-out spacer 14, the knobs 14a of the two pull-out spacers 14 are positioned to the right and left, respectively, so that the pull-out spacers 14 can easily be pulled out one by one. At the time such plural spacers are used, if the planar shape of the spacers is designed so that their knobs do not overlap each other, the pull-out spacers 14 can likewise be pulled out easily one by one.

Because the printer according to the embodiment has the above-described print head, a good printing operation can be performed without lowering the printing force.

Although the invention has been described above by way of an embodiment, the invention is not limited to the foregoing embodiment, and can be modified in various forms. For example, although the foregoing description of the embodiment has been given of the example where there are two pull-out spacers 14, the number of pull-out spacers may be one, or three or more.

Although the description of the embodiment has been given of the example where the thickness of each pull-out spacer 14 is set to about 0.05 mm, the thickness of the pull-out spacer 14 can be determined arbitrarily and the number of spacers 14 to be used can also be determined adequately in consideration of the degree or the like of wear-out of the wires 11. For example, the printer having the print head mounted therein may be provided with a counter which counts the number of printable characters with a specific wire 11 or the number of average printable characters with a plurality of wires 11, and an indicator for the count value of the counter, so that a plurality of pull-out spacers 14 are pulled out in a predetermined order.

Although the description of the embodiment has been given of the example where pull-out spacers 14 are arranged one on another alternately with one pull-out spacer 14 placed topside bottom on the other pull-out spacer 14, pull-out spacers 14 having knobs previously formed disproportionate to the right side and left side, respectively, may be used.

This application is based on Japanese Patent Application No. 2006-107274 filed on Apr. 10, 2006. The specification, claims and drawings of Japanese Patent Application No. 2006-107274 are incorporated herein by reference in the entirety.

### INDUSTRIAL APPLICABILITY

The present invention is contributable to technical innovation in the manufacturing industry for OA devices, or every industry using a printing apparatus.

1-8. (canceled)

9. A print head including: a plurality of wires having tip portions to be struck against a printing surface of a printing medium; a rotatable roller which slides on the printing medium to secure distances between the printing medium and the tip portions of the wires; a support for the roller; and a frame to which the support for the roller is attached, comprising:
a plurality of spacers between the support for the roller and the frame for adjusting the distances between the printing medium and the tip portions of the wires;
the spacers being held between the support for the roller and the frame so as to be outward of an outer periphery of the support for the roller in an initial state, in such a sequentially pull-outable manner that pulling-out of each of the spacers decreases the distances between the printing medium and the tip portions of the wires so as to correspond to wear of the tip portions of the wires; and
each of the spacers including a knob formed disproportionately at either right side or left side and being arranged one on another with a top of one facing a bottom of another alternately.

10. A print head including: a plurality of wires having tip portions to be struck against a printing surface of a printing medium; a rotatable roller which slides on the printing medium to secure distances between the printing medium and the tip portions of the wires; a support for the roller; and a frame to which the support for the roller is attached, comprising:
a plurality of spacers between the support for the roller and the frame for adjusting the distances between the printing medium and the tip portions of the wires;
the spacers being held between the support for the roller and the frame so as to be outward of an outer periphery of the support for the roller in an initial state, in such a sequentially pull-outable manner that pulling-out of each of the spacers decreases the distances between the printing medium and the tip portions of the wires so as to correspond to wear of the tip portions of the wires; and
each of the spacers including a knob formed disproportionately at either right side or left side, the knob having a hole formed therein.

11. The print head according to claim 9, wherein the knob has a hole formed therein.

12. The print head according to claim 9, wherein the support for the roller is fastened to the frame by a screw, and
the spacer has a groove which has one end open at a periphery of the spacer and through which the screw penetrates.

13. The print head according to claim 10, wherein the support for the roller is fastened to the frame by a screw, and
the spacer has a groove which has one end open at a periphery of the spacer and through which the screw penetrates.

14. The print head according to claim 9, further having a fixed spacer between the support for the roller and the frame, the fixed spacer being fixed therebetween together with the spacers.

15. The print head according to claim 10, further having a fixed spacer between the support for the roller and the frame, the fixed spacer being fixed therebetween together with the spacers.

16. A printed equipped with the print head as recited in claim 9, having a counter for counting a number of printable characters by the print head, and a display unit for displaying a counter value of the counter.

17. A printed equipped with the print head as recited in claim 10, having a counter for counting a number of printable characters by the print head, and a display unit for displaying a counter value of the counter.

18. A printed equipped with the print head as recited in claim 11, having a counter for counting a number of printable characters by the print head, and a display unit for displaying a counter value of the counter.

19. A printed equipped with the print head as recited in claim 12, having a counter for counting a number of printable characters by the print head, and a display unit for displaying a counter value of the counter.

20. A printed equipped with the print head as recited in claim 14, having a counter for counting a number of printable characters by the print head, and a display unit for displaying a counter value of the counter.
